(19) United States
(12) Patent Application Publication
(10) Pub. No.: US 2019/0169338 A1
(43) Pub. Date: Jun. 6, 2019

(54) FLUOROPOLYMERS FOR COATING APPLICATIONS

(71) Applicant: HONEYWELL INTERNATIONAL INC., Morris Plains, NJ (US)

(72) Inventors: Gang Xu, Shanghai (CN); Wanchao Jiang, Shanghai (CN); Siyuan Zhang, Shanghai (CN); Linlin Duan, Shanghai (CN); Zhe Ding, Shanghai (CN)

(21) Appl. No.: 16/200,034

(22) Filed: Nov. 26, 2018

Related U.S. Application Data
(60) Provisional application No. 62/593,461, filed on Dec. 1, 2017.

(51) Int. Cl. C08F 214/18; C08F 218/04; C08F 216/12

(52) U.S. Cl. CPC C08F 214/188; C08F 2800/10; C08F 216/12; C08F 218/04

(57) ABSTRACT

Copolymers formed by copolymerization of: (1) one or more hydrofluoroolefin monomer(s) selected from the group consisting of hydrofluoroethylenes, hydrofluoropropenes, hydrofluorobutenes, hydrofluoropentenes and combinations of these; (2) one or more aromatic vinyl ester monomer(s); (3) one or more vinyl ester monomer(s); and (4) one or more vinyl ether monomer(s), wherein at least a portion of said vinyl ether monomer is a hydroxyl group-containing vinyl ether monomer.

### CROSS REFERENCE

The present application claims the priority benefit of U.S. provisional application 62/593,461, filed Dec. 1, 2017, which is incorporated herein by reference.

### FIELD OF THE INVENTION

The present invention relates to novel fluoropolymers having excellent adhesion to substrates and excellent resistance to weathering and corrosion, as well as other advantageous properties, and coating compositions formed from such polymers having high solids content, and to methods of reducing the exposure of earth's atmosphere to volatile organic compounds (VOCs) while forming protective coatings on substrates.

### BACKGROUND OF THE INVENTION

Volatile organic compounds (VOCs) are volatile compounds of carbon that are subject to regulation by various government authorities, and for the purposes of the present invention the term is used consistent with proposed regulations established by the United States Environmental Protection Agency (EPA). More specifically, these proposed regulations establish that a compound of carbon is a VOC if it has a vapor pressure of less than about 0.1 millimeters of mercury at 20° C.

A variety of chemicals are within the definition of VOC, and some of these chemicals have short- and long-term adverse health effects when released into the atmosphere. Accordingly, many countries have regulations governing the release of such compounds into the earth's atmosphere. One relatively large source of release of such compounds into the environment has been from the solvents that are used in coating products such as, paints, varnishes, waxes, adhesives, inks and the like. Many cleaning, disinfecting, cosmetic, degreasing, and hobby products also contain VOCs as solvents or carriers. One method to reduce or eliminate the release of such compounds into the atmosphere is to capture and prevent release of the solvent as it evaporates from the coating composition. Such methods can involve, for example, the installation of a mechanism to capture the vapors and to process such vapors in an incinerator. However, as will be appreciated to those skilled in the art, a substantial capital cost and/or processing cost is incurred as a result of such operations, and such operations can sometimes add detrimentally to the time required to complete such coating operations.

In order to reduce and control the VOC emission into the earth's atmosphere, more and more countries have started to regulate VOC emissions. Such regulations include, in various countries, charging a VOC tax upon release of such compounds. Accordingly, there are many incentives to reduce the release of VOCs into the atmosphere.

### SUMMARY OF THE INVENTION

As used herein, the term “copolymer” means polymers having two or more different repeating units, and the term “fluorocopolymer” means copolymers in which at least one of the repeating units is based on a monomer that is a hydrofluoroolefin. The term “terpolymer” means polymers having three or more different repeating units, and the term “terfluorocopolymer” means terpolymers in which at least one of the repeating units is based on a monomer that is a hydrofluoroolefin. The term “tetrapolymer” is intended to include oligomers and copolymers having four or more different repeating units, and the term “tetrafluorocopolymer” means tetrapolymers in which at least one of the repeating units is based on a monomer that is a hydrofluoroolefin. Thus, a tetrapolymer derived from monomers A, B, C and D has repeating units (-A-), (—B—), (—C—) and (-D-), and a tetrafluorocopolymer derived from monomers A, B, C and D has repeating units (-A-), (—B—), (—C—) and (-D-), wherein at least one of these is a hydrofluoroolefin.

The repeating units according to the present invention can be arranged in any form, including as alternating copolymers, as periodic copolymers, statistical copolymers, block copolymers and graft copolymers.

One aspect of the present invention provides terfluorocopolymers, and preferably tetrafluorcopolymers, formed by copolymerization of:
(1) one or more hydrofluoroolefin monomer(s) selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these;
(2) one or more aromatic vinyl ester monomers, preferably a monomer represented by the formula CH₂═CH—O(C═O)-(A) wherein (A) represents a phenyl group with or without a side group. A preferred aromatic vinyl ester is vinyl benzoate.
(3) optionally, but preferably, one or more vinyl ester monomer(s); and
(4) one or more vinyl ether monomer(s), wherein at least a portion of said vinyl ether monomer is a hydroxyl group-containing vinyl ether monomer.

According to preferred aspects, the present invention provides tetrafluorocopolymers as described in the previous paragraph, wherein the polymer has a number average molecular weight of greater than about 10,000, preferably greater than about 12,000, and preferably in other embodiments greater than about 15,000, as measured according to the procedure described herein.

One aspect of the present invention provides methods of reducing the release of volatile organic compounds (VOCs) into the earth's atmosphere during coating operations of the type that permit the escape of VOCs into the earth's atmosphere. In preferred embodiments, the methods according to this aspect include the steps of:
(a) providing a substrate to be coated;
(b) providing a coating composition which is formed by steps comprising:
   (i) providing one or more fluorocopolymers by copolymerization of (1) one or more hydrofluoroolefin monomer(s) selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these, (2) one or more aromatic vinyl ester monomers, preferably a monomer represented by the formula CH₂═CH—O(C═O)-(A) wherein (A) represents a phenyl group with or without a side group, and more preferably vinyl benzoate, (3) one or more vinyl ester monomer(s), and (4) one or more vinyl ether monomer(s), wherein at least a portion of said vinyl ether monomer is a hydroxyl group-containing vinyl ether monomer, wherein the copolymer preferably has a number average molecular weight of greater than about 10,000, preferably greater than about 12,000, and certain other embodiments greater than about 15,000, as measured according the procedure as described herein; and
   (ii) providing a carrier for said one or more fluorocopolymers, said carrier comprising one or more VOC compounds; and
   (iii) combining said one or more fluorocopolymers with said carrier to produce a polymeric composition comprising not greater than about 30% by weight of said carrier, preferably with a solids content of at least about 70% by weight;
(c) coating the substrate with said coating composition; and
(d) forming a protective polymeric layer on said substrate by allowing at least a substantial portion of said VOCs in said carrier to evaporate into the earth's atmosphere, whereby said protective coating is formed.

Another aspect of the present invention provides methods for obtaining a VOC tax credit as a result of reducing the release of volatile organic compounds (VOCs) into the earth's atmosphere compared to a baseline coating operation of the type that permits the escape of VOCs into the earth's atmosphere. In preferred embodiments, methods according to this aspect include the steps of:
(a) establishing a baseline release of VOCs from an existing operation which involves coating of a substrate with an existing coating composition;
(b) providing a reduced VOC coating composition formed by steps comprising:
   (i) providing one or more fluoropolymers by copolymerization of (1) one or more hydrofluoroolefin monomer(s) selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these, (2) one or more aromatic vinyl ester monomers, preferably a monomer represented by the formula CH₂═CH—O(C═O)-(A) wherein (A) represents a phenyl group with or without a side group, and more preferably vinyl benzoate, (3) one or more vinyl ester monomer(s), and (4) one or more vinyl ether monomer(s), wherein at least a portion of said vinyl ether monomer is a hydroxyl group-containing vinyl ether monomer, wherein the copolymer preferably has a number average molecular weight of greater than about 10,000, preferably greater than about 12,000 and certain other embodiments greater than about 15,000, as measured according to the procedure as described herein; and
   (ii) providing a carrier for said one or more fluoropolymers, said carrier comprising one or more VOC compounds; and
   (iii) combining said one or more fluoropolymers with said carrier to produce a polymeric composition comprising not greater than about 30% by weight of said carrier, preferably with a solids content of at least about 70% by weight;
(c) coating the substrate with said reduced VOC coating composition; and
(d) forming a protective polymeric layer on said substrate by allowing at least a substantial portion of said VOCs in said carrier to evaporate into the earth's atmosphere, whereby said protective coating is formed and whereby the VOCs released using said reduced VOC coating compositions is reduced compared to said baseline release of VOC; and
(e) submitting to an appropriate governmental agency a claim for tax credit based at least in part on said reduction in VOCs released from said coating operation.

According to certain preferred embodiments, the fluorocopolymer coating composition formed by step (b) (as described above) of this invention has a solid content of from about 70% to about 90% by weight, and even more preferably in certain embodiments from about 75% to about 85% by weight. In preferred embodiments, the fluorocopolymer coating composition formed by step (b) of this invention has a solid content of greater than about 75%.

According to preferred embodiments, the fluorocopolymer coating composition formed by step (b) of this invention has a VOC content of less than about 450 g/l, more preferably less than about 400 g/l, and even more preferably less than about 350 g/l.

According to preferred embodiments, the fluorocopolymer coating composition formed by step (b) of this invention has a VOC content of from about 450 g/l to about 100 g/l, more preferably from about 400 g/l to about 200 g/l, and even more preferably from about 350 g/l to about 250 g/l.

As used herein, the term “hydrofluoroolefins” means compounds consisting of carbon, hydrogen and fluorine and having at least one carbon-carbon double bond. Hydrofluoroolefins include, but are not necessarily limited to, hydrofluoroethylenes, hydrofluoropropenes, hydrofluorobutenes and hydrofluoropentenes, and the like. Preferred hydrofluoroolefins used to form the coating composition of step (b) comprise one or more tetrafluoropropenes. The tetrafluoropropene(s) used in step (b) preferably comprise 1,3,3,3-tetrafluoropropene (HFO-1234ze) and/or 2,3,3,3-tetrafluoropropene (HFO-1234yf), with said 1,3,3,3-tetrafluoropropene preferably comprising, consisting essentially of or consisting of trans-1,3,3,3-tetrafluoropropene.

As used herein, the phrase “aromatic vinyl ester monomers” means vinyl ester monomers including an aromatic group. Examples of aromatic vinyl ester monomers include vinyl benzoate and vinyl cinnamate. Preferred aromatic vinyl ester monomers are monomers represented by the formula CH₂═CH—O(C═O)-(A) wherein (A) represents a phenyl group with or without a side group. More preferably, the aromatic vinyl ester monomers comprise, consist essentially of, or consist of vinyl benzoate. Although not wishing to be bound by any particular theory, the inventors believe that the conjugated double-bond structure in the aromatic vinyl ester monomer will effectively absorb ultraviolet light, which will lead to an improved weather durability of the resulting fluorocopolymer, including improved QUV-A, QUV-B and sunlight (Q-SUN and WOM testing) durability.

In preferred embodiments, the fluorocopolymer of step (b) is formed by solution copolymerization of the monomers represented by (1), (2), (3) and (4) of step (b)(i) (as described above). In preferred embodiments, step (b)(i) comprises solution copolymerizing:
(1) from about 40 mol % to about 60 mol %, and even more preferably from about 45 mol % to about 55 mol %, and even more preferably about 50 mol % of hydrofluoroolefin monomer(s), preferably selected from the group consisting of hydrofluoroethylenes, hydrofluoropropenes, hydrofluorobutenes and hydrofluoropentenes, more preferably from the group consisting of HFO-1234ze, HFO-1234yf and combinations of these, and even more preferably HFO-1234ze, with said HFO-1234ze preferably comprising, consisting essentially of or consisting of trans-HFO-1234ze;
(2) from about 2 mol % to about 40 mol %, and even more preferably from about 5 mol % to about 20 mol %, and even more preferably from about 10 mol % to about 15 mol % of aromatic vinyl ester monomer(s), preferably monomer(s) represented by the formula CH₂═CH—O(C═O)-(A) wherein (A) represents a phenyl group with or without a side group, and more preferably vinyl benzoate;
(3) from about 5 mol % to 45 mol % of vinyl ester or vinyl ether or both of them, more preferably from about 10 mol % to about 40 mol %, and even more preferably from about 20 mol % to about 40 mol %, represented by formula CH₂═CR¹—O(C═O)ₓR² and CH₂═CR³—OR⁴, respectively, wherein x is 1 and wherein R¹ and R³ are independently either hydrogen or a methyl group, preferably hydrogen, and wherein R² and R⁴ are independently selected from the group consisting of an unsubstituted straight-chain, branched-chain or alicyclic alkyl group having 1 to 12 carbon atoms, preferably from 2 to 8 carbon atoms; and
(4) from about 3 mol % to about 30 mol % of hydroxyalkyl vinyl ether, more preferably from about 3 mol % to about 20 mol %, and even more preferably from about 3 mol % to about 10 mol % represented by formula CH₂═CR³—O—R⁵—OH, where R³ is as defined above, preferably hydrogen, and R⁵ is selected from the group consisting of a C2 to C12 unsubstituted straight-chain, branched-chain or alicyclic alkyl group, more preferably an unsubstituted straight chain alkyl group having from 3 to 5 carbons, preferably 4 carbons, wherein the mol % are based on the total of the monomers in the copolymer formation step.

In addition, at the end of the solution copolymerization of the monomers as described in the preceding paragraph, there is a further optional step. That is, a radical transfer agent, preferably methanol, may optionally be reacted with the fluorocopolymer, preferably at an increased temperature from the copolymerization temperature, to produce an endcapped fluorocopolymer, preferably containing ether end groups. During the solution copolymerization of the monomers as described in the preceding paragraph, the end groups should be a CH₂* radical group or a CFH* radical group. Thus, addition of a radical transfer agent should serve to endcap the end groups of the fluorocopolymer, and the resulting endgroups should preferably be ether groups and/or alkyl groups. Both ether groups and alkyl groups are much more thermally stable than the existing carboxylic acid end groups, and thus will result in a more thermally stable, endcapped fluorocopolymer.

As used herein, the phrase “radical transfer agent” means a reagent capable of reacting with a CH₂* radical group or a CFH* radical group. Radical transfer agents include alcohols (which will form ether end groups), amines (which will form amine end groups) and hydrogen (which will form alkyl end groups). Preferably, the radical transfer agent is an alcohol, such as, for example, methanol, ethanol or isopropanol, and the endcapped fluorocopolymer contains ether end groups. More preferably, the radical transfer agent is methanol, and the endcapped fluorocopolymer contains ether end groups.

According to preferred embodiments, the fluorocopolymer coating composition formed by step (b) of this invention has a VOC content of from about 450 g/l to about 100 g/l, more preferably from about 400 g/l to about 200 g/l, and even more preferably from about 350 g/l to about 250 g/l.

Hydrofluoroolefins include but are not necessarily limited to hydrofluoroethylene, hydrofluoropropene, hydrofluorobutene and hydrofluoropentene, and the like. According to certain preferred embodiments, the hydrofluoroolefin used to form the coating composition of step (b) comprises 1,3,3,3-tetrafluoropropene (HFO-1234ze) and/or 2,3,3,3-tetrafluoropropene (HFO-1234yf), with said HFO-1234ze preferably comprising, consisting essentially of or consisting of trans- HFO-1234ze.

In preferred embodiments, the fluorocopolymer of step (b)(i) is formed by copolymerization, and preferably solution copolymerization, of the monomers represented by (1), (2), (3) and (4) as follows:
(1) from about 40 mol % to about 60 mol %, and even more preferably from about 45 mol % to about 55 mol %, and even more preferably about 50 mol % of hydrofluoroolefin monomers, preferably selected from the group consisting of hydrofluoroethylenes, hydrofluoropropenes, hydrofluorobutenes and hydrofluoropentenes, preferably from the group consisting of HFO-1234ze, HFO-1234yf and combinations of these, and even more preferably HFO-1234ze with said HFO-1234ze preferably comprising, consisting essentially of or consisting of trans-HFO-1234ze;
(2) from about 2 mol % to about 40 mol %, and even more preferably from about 5 mol % to about 20 mol %, and even more preferably from about 10 mol % to about 15 mol % of aromatic vinyl ester monomer(s), preferably monomer(s) represented by the formula CH₂═CH—O(C═O)-(A) wherein (A) represents a phenyl group with or without a side group, and more preferably vinyl benzoate;
(3A) from about 10 mol % to about 40 mol % of vinyl ester, more preferably from about 10 mol % to about 30 mol %, and even more preferably from about 10 mol % to about 20 mol %, represented by formula CH₂═CR¹—O(C═O)ₓR², wherein x is 1 and wherein R¹ is either hydrogen or a methyl group, and wherein R² is selected from the group consisting of an unsubstituted straight-chain, branched-chain or alicyclic alkyl group having 1 to 12 carbon atoms;
(3B) from about 10 mol % to about 40 mol % of vinyl ether, more preferably from about 10 mol % to about 30 mol %, and even more preferably from about 10 mol % to about 20 mol %, represented by formula CH₂═CR³—OR⁴, wherein R³ is independently either hydrogen or a methyl group and wherein R⁴ is independently selected from the group consisting of an unsubstituted straight-chain, branched-chain or alicyclic alkyl group having 1 to 12 carbon atoms; and
(4) from about 3 mol % to about 30 mol % of hydroxyalkyl vinyl ether, more preferably from about 3 mol % to about 20 mol %, and even more preferably from about 3 mol % to about 10 mol %, represented by formula CH₂═CR³—O—R⁵—OH, where R³ is as defined above, preferably hydrogen, and R⁵ is selected from the group consisting of a C2 to C12 unsubstituted straight-chain, branched-chain or alicyclic alkyl group, wherein the mol % are based on the total of the monomers in the copolymer formation step.

In addition, at the end of the copolymerization of the monomers as described in the preceding paragraph, there is a further optional step. That is, a radical transfer agent, preferably methanol, may optionally be reacted with the fluorocopolymer, preferably at an increased temperature from the copolymerization temperature, to produce an endcapped fluorocopolymer, preferably containing ether end groups.

In preferred embodiments, the fluoropolymer coating composition formed by step (b) of the present invention has a solids content of from about 70% to about 90% by weight, more preferably in certain embodiments of from about 75% to about 85% by weight, and at the same time has a VOC content of from about 450 g/l to about 100 g/l, more preferably from about 400 g/l to about 200 g/1, and even more preferably from about 300 g/l to about 200 g/l.

According to a preferred embodiment of the present invention, the co-polymer formation step (b)(i) comprises providing one or more fluorocopolymers by copolymerization of:
(1) first monomer(s) consisting essentially of HFO-1234ze and/or HFO-1234yf, wherein the HFO-1234ze is preferably trans-HFO-1234ze, preferably in an amount of from about 5 mol % to about 60 mol %, and more preferably from about 10 mol % to about 55 mol %;
(2) second monomer comprising a monomer represented by the formula CH₂═CH—O(C═O)-(A) wherein (A) represents a phenyl group with or without a side group, preferably in an amount of from about 2 mol % to about 40 mol %, more preferably in an amount of from about 5 mol % to about 20 mol %, and more preferably from about 10 mol % to about 15 mol %;
(3) third monomer(s) comprising:
   A) vinyl ester monomer(s), preferably in an amount of from about 5 mol % to about 45 mol %, more preferably from about 10 mol % to about 30 mol %, and even more preferably from about 10 mol % to about 20 mol %, represented by formula CH₂═CR¹—O(C═O)ₓR², wherein x is 1 and wherein R¹ is either hydrogen or a methyl group, and wherein R² is selected from the group consisting of a substituted or unsubstituted straight-chain or branched-chain alkyl group having 5 to 12 carbon atoms, wherein said alkyl group includes at least one tertiary or quaternary carbon atom, and
   B) vinyl ether monomer(s), preferably in amounts of from about 10 mol % to about 40 mol % of vinyl ether, more preferably from about 5 mol % to about 45 mol %, more preferably from about 10 mol % to about 30 mol %, and even more preferably from about 10 mol % to about 20 mol %, represented by formula CH₂═CR³—OR⁴ respectively, wherein R³ is independently either hydrogen or a methyl group and wherein R⁴ is independently selected from the group consisting of a substituted or unsubstituted straight-chain or branched-chain alkyl group having 1 to 5 carbon atoms; and
(4) fourth monomer(s) selected from hydroxyl group-containing vinyl ether monomer(s), preferably in an amount of from about 3 mol % to about 60 mol % of hydroxy vinyl ether monomer, preferably in an amount of from about 3 mol % to about 30 mol %, more preferably from about 3 mol % to about 20 mol %, and even more preferably from about 3 mol % to about 10 mol %, represented by formula CH₂═C—R⁵—OH, where R⁵ is selected from the group consisting of a C2 to C6 substituted or unsubstituted straight-chain or branched-chain alkyl group, wherein the mol % are based on the total of the monomers in the copolymer formation step.

In addition, at the end of the copolymerization of the monomers as described in the preceding paragraph, there is a further optional step. That is, a radical transfer agent, preferably methanol, may optionally be reacted with the fluorocopolymer, preferably at an increased temperature from the copolymerization temperature, to produce an endcapped fluorocopolymer, preferably containing ether end groups.

As used herein, unless otherwise specifically indicated, reference to mol % is to the mol % of monomers used in the formation of the fluorocopolymer of the present invention, based on the total of the monomers.

In certain embodiments of the process, the copolymer formed by step (b) of the present invention has a number average molecular weight as measured by gel phase chromatography (“GPC”) according to the method described in Skoog, D. A., Principles of Instrumental Analysis, 6th ed.; Thompson Brooks/Cole: Belmont, Calif., 2006, Chapter 28, which is incorporated herein by reference, of from about 5000 to 50,000, more preferably from about 12,000 to about 20,000 and in certain embodiments a weight average molecular weight preferably from about 5000 to about 30,000, and more preferably from about 20,000 to about 30,000. The values described herein for molecular weight are based on measurements that use an Agilent-PL gel chromatography column (5 um MIXED-C 300*7.5 mm). The mobile phase is tetrahydrofuran (THF) at a flow rate of 1 ml/minute and a temperature of 35° C. A refractive index detector is used. The unit is calibrated with polystyrene narrow standard available from Agilent.

In certain embodiments, the coating composition formed by step (b) has a VOC content of less than about 450 g/1, more preferably less than about 400 g/l, and even more preferably less than about 300 g/l. The values described herein for VOC are based on measurements made according to ASTM D1644, which covers the standard test method for the determination of the weight percent volatile content of solvent-borne and water-borne coatings. The procedure for calculating the Volatile Organic Compound (VOC) content of a liquid coating is to obtain a sample of the liquid coating to be tested and then weighing the coating in an aluminum foil dish to obtain the weight to the nearest 0.1 mg, which is designated in the following calculations as (W1). Add to the aluminum foil dish 3±1 ml of toluene solvent to form the coating specimen. The specimen is then draw into the syringe and the filled syringe is placed on the scale and the scale is tarred. The cap is removed from the syringe and the specimen is dispensed from the syringe into the dish to the target specimen weight (0.3±0.1 g if the expected result is =<40% volatile and 0.5±0.1 g if the expected result is >40% volatile. The specimen is spread out in the dish to cover the bottom of the dish completely with as uniform of a thickness as possible. Obtain and record the weight of the specimen to the nearest 0.1 mg, which is designated as the Specimen Weight (SA) in the following calculations. The foil dish containing the specimens is then heated in the forced draft oven for 60 min at 110° C. Each dish is removed from the oven, placed immediately in a desiccator, cooled to ambient temperature, weighed to the nearest 0.1 mg, and this weight is recorded, and is indicated as W2 in the following calculations.

To calculate the VOC, V, in the liquid coating, the following equations are used:

VA=1000*DA*(W2−W1)/SA

where:

VA=% volatiles (first determination),

W1=weight of dish,

W2=weight of dish plus specimen,

SA=specimen weight,

DA=specimen specific gravity, and

VB=% volatiles (duplicate determination; calculate in same manner as VA).

As used herein, the term “substrate” refers to any device or article, or part of a device or article, to be coated.

As used herein, the term “carrier” is intended to refer to a component of a composition that serves to solvate, disperse and/or emulsify a monomeric or polymeric component of a composition.

### BRIEF DESCRIPTION OF DRAWINGS

FIG. 1 shows a graph comparing the QUV-B durability of FPVE-VBZ to that of FPVE.

FIG. 2 shows a graph comparing the QUV-B durability of FPVE-VBZ (30% VBZ) and FPVE-VBZ (5% VBZ) to that of FPVE.

### DETAILED DESCRIPTION OF THE INVENTION

As described above, preferred aspects of the present invention involve coating methods that provide reduced VOC emissions while at the same time providing effective and efficient protective coatings on substrates. As those skilled in the art will appreciate, the quality of a protective coating applied to a substrate can be measured by a variety of coating properties that, depending on the particular application, are important for achieving a commercially successful coating on a given substrate. These properties include but are not limited to: (1) viscosity, (2) gloss retention and (3) substrate adhesion.

Viscosity as used herein is measured according the ASTM Standard Test Method for Measuring Solution Viscosity of Polymers with Differential Viscometer, Designation D5225-14. According to this method as used herein, the viscometer used is a Brookfield viscometer (DV-II+Pro) using spindles S18/S31 using torque values from between 40% and 80% at room temperatures of about 23±2° C. If a solvent is used for the measurements, it is butyl acetate.

According to certain preferred embodiments, the coating compositions formed according to the present methods exhibit: (1) a solid concentration of at least about 70% by weight; (2) a viscosity, as measured by the ASTM Standard Test Method for Measuring Solution Viscosity of Polymers with Differential Viscometer, Designation D5225-14, of not greater than about 1700 mPa-s at about 23±2° C.; (3) a VOC content of not greater than about 450 g/l, more preferably not greater than about 400 g/l, and even more preferably not greater than about 350 g/1; and (4) a color change of below 2% after 600 hours of QUV-B testing.

In preferred embodiments, the polymers of the present invention have a hydroxyl value of greater than about 70, and in other preferred embodiments have a hydroxyl value of greater than about 90. As mentioned above, the ability to achieve such a method resides, in part, on the judicious selection of the type and the amounts of the various components that are used to form the fluoropolymer and the coating compositions of the present invention.

Monomers

Hydrofluoroolefins

The hydrofluoroolefin monomers according to the methods of the present invention can include in certain preferred embodiments hydrofluoroethylene monomer, that is, compounds having the formula CX¹X²═CX³X⁴; wherein X¹, X², X³, X⁴ are each independently selected from H or F or Cl atom, but at least one of them is a hydrogen atom. Examples of hydrofluoroethylene monomers include, among others:

CH₂═CHF,

CHF═CHF,

CH₂═CF₂, and

CHF═CF₂.

The hydrofluoroolefin monomers according to certain preferred aspects of the methods of the present invention include, and preferably consists essentially of or consist of hydrofluoropropenes having the formula CX⁵X⁶═CX⁷CX⁸X⁹X¹⁰; wherein X⁵, X⁶, X⁷, X⁸, X⁹ and X¹⁰ are independently selected from H or F or Cl atom, but at least one of them is a hydrogen atom and another is a fluorine atom. Examples of hydrofluoropropene monomers include, among others:

CH₂═CFCF₃ (HFO-1234yf),

trans-CHF═CHCF₃ (trans-HFO-1234ze),

CHCl═CFCF₃ and

CH₂═CHCF₃.

In preferred embodiments, the hydrofluoroolefin comprises, consists essentially of or consists of HFO-1234yf and/or HFO-1234ze. In preferred embodiments, the hydrofluoroolefin comprises, consists essentially of or consists of HFO-1234ze, with said HFO-1234ze preferably comprising, consisting essentially of or consisting of trans-HFO-1234ze.

The hydrofluoroolefin monomers according to certain preferred aspects of the methods of the present invention include hydrofluorobutene according to the following formula: CX¹¹X¹²═CX¹³CX¹⁴X¹⁵CX¹⁶X¹⁷X¹⁸; wherein X¹¹, X¹², X¹³, X¹⁴, X¹⁵, X¹⁶, X¹⁷ and X¹⁸ are independently selected from H or F or Cl atom, but at least one of them is a hydrogen atom and at least one is a fluorine atom. Examples of hydrofluorobutene include, among others, CF₃CH═CHCF₃.

Vinyl Esters

The copolymers in accordance with the present invention preferably are also formed from vinyl ester monomer units, preferably in amounts of from about 5 mol % to about 45 mol %, more preferably from about 10 mol % to about 30 mol %, and even more preferably from about 10 mol % to about 20 mol %. In preferred embodiments, the vinyl ester monomer(s) are represented by the formula CH₂═CR¹—O(C═O)ₓR², wherein x is 1 and wherein R¹ is either hydrogen or a methyl group, and wherein R² is selected from the group consisting of a substituted or unsubstituted, preferably unsubstituted, straight-chain or branched-chain, preferably branched chain, alkyl group having 5 to 12 carbon atoms, more preferably having from 5 to 10 carbon atoms, and even more preferably 8 to 10 carbon atoms. In preferred embodiments, the alkyl group includes at least one tertiary or quaternary carbon atom. In highly preferred embodiments, the vinyl ester includes at least one quaternary carbon according to the following formula:

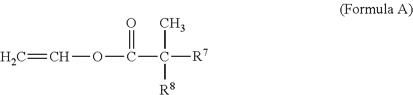

where each of R⁷ and R⁸ are alkyl groups, preferably branched alkyl groups, that together contain from 5 to about 8, more preferably from 6 to 7, carbon atoms.

Examples of vinyl ester monomers that are preferred according to certain preferred embodiments include vinyl acetate, vinyl propionate, vinyl butyrate, vinyl pivalate, vinyl capronate, vinyl laurate, VEOVA-9 (vinyl versatate ester formed from a C9 carbocylic acid, produced by Momentive), VEOVA-10 (vinyl versatate ester formed from a C10 carbocyclic acid, produced by Momentive) and vinyl cyclohexanecarboxylate. Each of VEOVA-9 and VEOVA-10 contain at least one quaternary carbon according to Formula A above. According to preferred embodiments, the vinyl ester comprises vinyl versatate ester having from 11 to 12 carbon atoms in the molecule, preferably with at least one quaternary carbon according to Formula A above.

Vinyl Ethers

The copolymers in accordance with the present invention preferably are also formed from vinyl ether monomer units, preferably in amounts of from about 5 mol % to about 45 mol %, more preferably from about 10 mol % to about 30 mol %, and even more preferably from about 10 mol % to about 20 mol %. In preferred embodiments, the vinyl ester monomer(s) are represented by the formula CH₂═CR³—OR⁴, wherein R³ is independently either hydrogen or a methyl group and wherein R⁴ is selected from the group consisting of a substituted or unsubstituted, preferably unsubstituted, straight-chain or branched-chain, preferably straight chain, alkyl group having 1 to 5 carbon atoms, more preferably 1 to 3 carbon atoms. Examples of vinyl ether monomers that are preferred according to certain preferred embodiments include alkyl vinyl ethers such as methyl vinyl ether, ethyl vinyl ether, propyl vinyl ether, n-butyl vinyl ether, isobutyl vinyl ether, hexyl vinyl ether, octyl vinyl ether, decyl vinyl ether and lauryl vinyl ether. Vinyl ethers including an alicyclic group can also be used, for example, cyclobutyl vinyl ether, cyclopentyl vinyl ether and cyclohexyl vinyl ether. According to preferred embodiments, the vinyl ether comprises, consists essentially of, or consists of ethyl vinyl ether.

Preferably in those embodiments in which vinyl ether and vinyl ester monomers are both present, the amount of vinyl ether and vinyl ester monomers together comprise from about 25 mol % to about 45 mol % of the total monomers.

Hydroxy Vinyl Ethers

The copolymers in accordance with the present invention preferably are also formed from hydroxyl vinyl ether monomer units, preferably in amounts of from about 3 mol % to about 60 mol % of hydroxy vinyl ether monomer, preferably in an amount of from about 3 mol % to about 30 mol %, more preferably from about 3 mol % to about 20 mol %, and even more preferably from about 3 mol % to about 10 mol %. In preferred embodiments, the hydroxyl vinyl ether monomer(s) are represented by the formula CH₂═CR³—O—R⁵—OH, where R³ is as defined above, preferably hydrogen, and where R⁵ is selected from the group consisting of a C2 to C6 substituted or unsubstituted, preferably unsubstituted, straight-chain or branched-chain, prefeethrably straight chain, alkyl group. Examples of preferred hydroxyalkyl vinyl ether monomers include hydroxyl-ethyl vinyl ether, hydroxypropyl vinyl ether, hydroxybutyl vinyl ether, hydroxypentyl vinyl ether and hydroxyhexyl vinyl ether. In certain embodiments, the copolymer is formed from about 5 mol % to about 20 mol % of hydroxyalkyl vinyl ether monomers, based on the total weight of the monomer.

In preferred embodiments, the co-monomers according to the fluorocopolymer formation step (b)(i) (as described above) comprise, and preferably consist essentially of:
(1) first monomer consisting essentially of HFO-1234ze, preferably in an amount of from about 20 mol % to about 30 mol %, and even more preferably from about 22 mol % to about 27 mol %, and even more preferably about 25 mol %,
(2) second monomer consisting essentially of vinyl benzoate, preferably in an amount of from about 1 mol % to about 40 mol %, and even more preferably from about 2 mol % to about 30 mol %, and even more preferably from about 5 mol % to about 20 mol %,
(3) third monomer(s) comprising:
   A) vinyl ester monomer represented by formula CH₂═CR¹—O(C═O)ₓR² wherein x is 1 and wherein R¹ is either hydrogen or a methyl group, preferably hydrogen, and wherein R² is a substituted or unsubstituted branched or straight-chain alkyl group having 6 to 8 carbon atoms, preferably an unsubstituted branched-chain alkyl group having 6 to 8 carbon atoms, wherein said alkyl group preferably includes at least one tertiary or quaternary carbon atom, wherein said vinyl ester monomer is present in an amount of from about 5 mol % to about 45 mol %, more preferably from about 10 mol % to about 30 mol %, and even more preferably from about 10 mol % to about 20 mol %; and
   B) vinyl ether monomer(s), represented by formula CH₂═CR³—OR⁴ respectively, wherein R³ is independently either hydrogen or a methyl group, preferably hydrogen, and wherein R⁴ is selected from the group consisting of a substituted or unsubstituted straight-chain or branched-chain, preferably straight chain, alkyl group having 1 to 3 carbon atoms, preferably 2 carbon atoms, said vinyl ether monomer(s) preferably being present in amounts of from about 10 mol % to about 40 mol %, more preferably from about 5 mol % to about 45 mol %, more preferably from about 10 mol % to about 30 mol %, and even more preferably from about 10 mol % to about 20 mol %; and
(4) fourth monomer(s) consisting of hydroxyalkyl vinyl ether represented by formula CH₂═CR³—O—R⁵—OH, where R³ is methyl or hydrogen, preferably hydrogen, and R⁵ is selected from the group consisting of a substituted or unsubstituted straight-chain or branched-chain C3 to C5 alkyl, preferably C4, unsubstituted straight-chain alkyl group, wherein the amount of said fourth monomer is preferably present in an amount of from about 3 mol % to about 30 mol %.

### Copolymer Formation Methods

It will be appreciated by those skilled in the art, based on the teachings contained herein, that copolymers of the present invention may be formed to achieve the preferred characteristics described herein using a variety of techniques, and all such techniques are within the scope of the present invention.

In preferred embodiments, the fluorocopolymer is preferably produced in a polymerization system that utilizes a carrier for the monomer/polymer during and/or after formation. According to one preferred embodiment the carrier acts as a solvent and/or dispersant for the monomer and/or polymer, and such operations include dispersion, emulsion and solution polymerization. Examples of carriers in such systems, including preferably solvents for solution polymerization, include: esters, such as methyl acetate, ethyl acetate, propyl acetate and butyl acetate; ketones, such as acetone, methyl ethyl acetone and cyclohexanone; aliphatic hydrocarbons, such as hexane, cyclohexane, octane, nonane, decane, undecane, dodecane and mineral spirits; aromatic hydrocarbons, such as benzene, toluene, xylene, naphthalene, and solvent napthta; alcohols, such as methanol, ethanol, tert-butanol, iso-propanol, ethylene glycol monoalkyl ethers; cyclic ethers, such as tetrahydrofuran, tetrahydropyran, and dioxane; fluorinated solvents, such as HCFC-225 and HCFC-141b; dimethyl sulfoxide; and the mixtures thereof.

It is contemplated that the temperature conditions used in the polymerization process of the present invention can be varied according to the particular equipment and applications involved and all such temperatures are within the scope of the present invention. Preferably, the polymerization is conducted at a temperature in a range of from about 30° C. to about 150° C., more preferably from about 40° C. to about 100° C., and even more preferably from about 50° C. to about 70° C., depending on factors such as the polymerization initiation source and type of the polymerization medium.

In certain preferred embodiments, it is preferred that the solution polymerization is conducted under conditions under which the total amount of the solvent used in the copolymerization process, based on the weight of the solvent and monomer in the solution, is from about 10 wt % to about 40 wt %, more preferably in amounts of from about 10 wt % to about 30 wt %, and more preferably in certain embodiments in an amount of from about 15% to about 25%. In certain of such embodiments, the solvent used in the solution copolymerization process comprises, preferably consists essentially of, and more preferably in certain embodiments consists of C2-C5 alkyl acetate, and even more preferably butyl acetate.

In preferred embodiments, the copolymer as formed in accordance with the preferred methods described herein is prepared by copolymerizing those monomers under conditions effective to achieve a copolymer having a number average molecular weight of 5000 to 50,000, or in some embodiments 5000 to 10,000 as measured by gel phase chromatography (“GPC”) according to the method described in Skoog, D. A., Principles of Instrumental Analysis, 6th ed.; Thompson Brooks/Cole: Belmont, Calif., 2006, Chapter 28, which is incorporated herein by reference. In certain embodiments, the copolymer has a number average molecular weight that is greater than about 10,000, and even more preferably from 10,000 to about 14,000. According to certain preferred embodiments, the copolymer has a molecular weight distribution of 2 to 10, more preferably 2.5 to 8, and most preferably 3 to 6. Applicants have found that in certain embodiments the use of copolymers having a molecular weight less than 5000 produces weatherability and chemical resistance of the protective coating that is less than is desired for some applications, and that when the polymers have a molecular weight of more than 50,000, coating compositions having viscosities that may negatively impact the spreading or coating properties of the coating compositions and hence difficulties in the coating operations result.

In preferred embodiments, the formation of fluorocopolymer coating compositions comprises, and preferably consists essentially of:
(i) providing one or more fluorocopolymers by copolymerization of
   (1) first monomer consisting essentially of HFO-1234ze, with said HFO-1234ze preferably comprising, consisting essentially of or consisting of trans-HFO-1234ze, preferably in an amount of from about 20 mol % to about 30 mol %, and even more preferably from about 22 mol % to about 27.5 mol %, and even more preferably about 25 mol %;
   (2) second monomer(s) consisting essentially of vinyl benzoate, preferably in an amount of from about 1 mol % to about 40 mol %, and even more preferably from about 2 mol % to about 30 mol %, and even more preferably from about 5 mol % to about 20 mol %;
   (3) third monomers comprising:
      A) vinyl ester monomer represented by formula CH₂═CR¹—O(C═O)ₓR² wherein x is 1 and wherein R¹ is either hydrogen or a methyl group, preferably hydrogen, and wherein R² is an unsubstituted branched-chain alkyl group having 6 to 8 carbon atoms, wherein said alkyl group preferably includes at least one tertiary or quaternary carbon atom, wherein said vinyl ester monomer is present in an amount of from about 5 mol % to about 45 mol %, more preferably from about 10 mol % to about 30 mol %, and even more preferably from about 10 mol % to about 20 mol %; and
      B) vinyl ether monomer(s), represented by formula CH₂═CR³—O—R⁴, wherein R³ is either hydrogen or a methyl group, preferably hydrogen, and wherein R⁴ is selected from the group consisting of a substituted or unsubstituted straight-chain or branched-chain, preferably straight chain, alkyl group having 1 to 3 carbon atoms, preferably 2 carbon atoms, said vinyl ether monomer(s) preferably being present in amounts of from about 10 mol % to about 40 mol %, more preferably from about 5 mol % to about 45 mol %, more preferably from about 10 mol % to about 30 mol %, and even more preferably from about 10 mol % to about 20 mol %; and
   (4) fourth monomer(s) consisting of hydroxyalkyl vinyl ether represented by the formula CH₂═CR³—O—R⁵—OH, where R³ is methyl or hydrogen, preferably hydrogen, and R⁵ is selected from the group consisting of a C3 to C5, preferably C4, unsubstituted straight-chain alkyl group, wherein the amount of said third monomer is preferably from about 3 mol % to about 30 mol %;
   and at the end of the copolymerization of these monomers, optionally reacting a radical transfer agent, preferably methanol, with the fluorocopolymer, preferably at an increased temperature from the copolymerization temperature, to produce an endcapped fluorocopolymer, preferably containing ether end groups;
(ii) providing a carrier for said one or more fluorocopolymers, said carrier comprising one or more VOC compounds and preferably selected from aromatic hydrocarbons such as xylene and toluene; alcohols such as n-butanol; esters such as butyl acetate; ketones such as methyl isobutyl ketone, and glycol ethers such as ethyl cellusolve, with C2-C5 alkyl acetate being preferred, and even more preferably comprising, consisting essentially of, or consisting of butyl acetate; and
(iii) combining said one or more fluorocopolymers with said carrier to produce a polymeric composition comprising not greater than about 30% by weight of said carrier, preferably with a solids content of at least about 70% by weight. According to preferred embodiments, the fluorocopolymer composition of the present invention, and in particular the fluorocopolymer formed as described in the preceding sentence, has a polymer number average molecular weight as measured by gel phase chromatography (“GPC”) according to the method described in Skoog, D. A., Principles of Instrumental Analysis, 6th ed.; Thompson Brooks/Cole: Belmont, Calif., 2006, Chapter 28, which is incorporated herein by reference, of from about 5000 to 50,000, more preferably from about 7000 to about 15000, and has a solids content of from about 70% to about 90% by weight, and even more preferably from about 70% to about 85% by weight, and preferably a VOC content of less than about 400 g/l, more preferably from about 400 g/l to about 100 g/l, and even more preferably from about 350 g/l to about 200 g/l. It is also preferred in such embodiments as described in the present application in general, and in this paragraph in particular, that the coating compositions of the present invention have a viscosity at 25° C. of less than about 1900 mPa-s, more preferably less than about 1800 mPa-s and even more preferably of less than about 1700 mPa-s as measured by Ford Cup at least at one of 12 revolutions per minutes (r/m), 30 r/m and 60 r/m, and preferably at all three speeds, preferably as measured according to ASTM D1200-10(2014) or ASTM D2196 as appropriate.

In preferred embodiments, the formation of fluorocopolymer coating compositions comprises, and preferably consists essentially of:
(i) providing one or more fluorocopolymers by copolymerization of
   (1) first monomer consisting essentially of HFO-1234ze, with said HFO-1234ze preferably comprising, consisting essentially of or consisting of trans-HFO-1234ze in an amount of from about 40 mol % to about 60 mol %, and even more preferably from about 45 mol % to about 55 mol %, and even more preferably about 50 mol %,
   (2) second monomer(s) consisting essentially of vinyl benzoate, preferably in an amount of from about 1 mol % to about 40 mol %, and even more preferably from about 2 mol % to about 30 mol %, and even more preferably from about 5 mol % to about 20 mol %,
   (3) third monomer(s) comprising:
      A) vinyl ester monomer represented by formula CH₂═CR¹—O(C═O)ₓR² wherein x is 1 and wherein R¹ is either hydrogen or a methyl group, preferably hydrogen, and wherein R² is an unsubstituted branched-chain alkyl group having 6 to 8 carbon atoms including at least one tertiary carbon atom, wherein said vinyl ester monomer is present in an amount of from about 5 mol % to about 45 mol %, more preferably from about 10 mol % to about 30 mol %, and even more preferably from about 10 mol % to about 20 mol %; and
      B) vinyl ether monomer(s), represented by formula CH₂═CR³—O—R⁴, wherein R³ is either hydrogen or a methyl group, preferably hydrogen, and wherein R⁴ is selected from the group consisting of a substituted or unsubstituted straight-chain or branched-chain, preferably straight chain, alkyl group having 1 to 3 carbon atoms, preferably 2 carbon atoms, said vinyl ether monomer(s) preferably being present in amounts of from about 10 mol % to about 40 mol %, more preferably from about 5 mol % to about 45 mol %, more preferably from about 10 mol % to about 30 mol %, and even more preferably from about 10 mol % to about 20 mol %; and
   (4) fourth monomer(s) consisting of hydroxyalkyl vinyl ether represented by the formula CH₂═CR³—O—R⁵—OH, where R³ is either hydrogen or a methyl group and R⁵ is selected from the group consisting of a substituted or unsubstituted straight-chain or branched-chain C3 to C5 alkyl, preferably C4, unsubstituted straight-chain alkyl group, wherein the amount of said forth monomer is preferably from about 3 mol % to about 30 mol %;
   and at the end of the copolymerization of these monomers, optionally reacting a radical transfer agent, preferably methanol, with the fluorocopolymer, preferably at an increased temperature from the copolymerization temperature, to produce an endcapped fluorocopolymer, preferably containing ether end groups; and
(ii) providing a carrier for said one or more fluorocopolymers, said carrier comprising one or more VOC compounds selected from aromatic hydrocarbons such as xylene and toluene; alcohols such as n-butanol; esters such as butyl acetate; ketones such as methyl isobutyl ketone, and glycol ethers such as ethyl cellusolve, with C2-C5 alkyl acetate being preferred, and even more preferably comprising, consisting essentially of, or consisting of butyl acetate; and
(iii) combining said one or more fluorocopolymers with said carrier to produce a polymeric composition comprising not greater than about 30% by weight of said carrier, preferably with a solids content of at least about 70% by weight.

### Coating Composition Formation Methods

The copolymers as formed in accordance with the procedures described herein may then be used to form various coating compositions that have the substantial advantages described above. For example, various solvents can be used for the preparation of solution-type paints or coatings by adding those solvents to the fluorocopolymer of the present invention formed as described herein. In certain embodiments, preferred solvents for formation of the coating composition include aromatic hydrocarbons such as xylene and toluene; alcohols such as n-butanol; esters such as butyl acetate; ketones such as methyl isobutyl ketone, and glycol ethers such as ethyl cellusolve and various commercial thinners.

In certain embodiments, the coating composition of the present invention has a solid content of from about 70% to about 90% by weight based on the total weight of the coating composition, and more preferably in certain embodiments from about 75% to about 85% by weight of solids. In certain preferred embodiments, the solids comprise and preferably consist essentially of the copolymers of the present invention and/or cross-linked copolymers formed using the copolymers of the present invention. Although it is contemplated that those skilled in the art will be able to form coatings using the present compositions according to any one of known methods, in preferred embodiments the coating is formed by brushing, a rolling, air spraying, airless spraying, flow coating, roller coating, a spin coating, and the like, and any combination of these may be used. Furthermore, the coating can be applied on various substrates. The coating film can be formed directly on a substrate or via a primer or if necessary, via an undercoating layer. Although all thicknesses are within the scope of the present invention, in preferred embodiments the outermost cured coating film layer has a layer thickness of from about 20 to about 30 μm.

### EXAMPLES

The present invention is further illustrated by the following non-limiting examples.

### Example 1—Fluoropolymer Preparation

A solution polymerization operation is carried out by charging into a 1000 ml stainless steel autoclave equipped with a stirrer the components as indicated in the following Table 1:

TABLE 1

| | | | Wt | | Mono- |
|---|---|---|---|---|---|
| | | | % of | Mono- | mer, |
| COMPONENT | | Weight, | solu- | mer | mol % of |
| TYPE | NAME | grams | tion | Moles | polymer |
| Solvent | butyl acetate | 61.6 | 9.2 | | |
| First | trans-1,3,3,3- | 253 | 37.8 | 2.22 | 50 |
| Monomer | tetrafluoropropene | | | | |
| (HFO) | (trans-HFO-1234ze) | | | | |
| Second | vinyl benzoate | 118.4 | 17.7 | 0.8 | 18 |
| Monomer | | | | | |
| Third | VEOVA-10 | 157.4 | 23.5 | 0.8 | 18 |
| Monomer | | | | | |
| (vinyl ester) | | | | | |
| Fourth | hydroxybutylvinyl | 72.2 | 10.8 | 0.62 | 14 |
| Monomer | ether | | | | |
| (alkylhy- | | | | | |
| droxy ether) | | | | | |
| Initiator | tert-Butyl | 6.5 | 1.0 | | |
| | peroxypivalate | | | | |

The butyl acetate, the vinyl benzoate monomer, the vinyl ester monomer (VEOVA-10), the hydroxybutyl vinyl ether, the initiator and 15 grams of zinc oxide were charged into the vessel. The mixture was solidified with liquid nitrogen, and deaerated to remove the dissolved air. Then, the trans-1,3,3,3-tetrafluoropropene (trans-HFO-1234ze) was added to the mixture in the autoclave, and the mixture was then gradually heated to about 57° C. The mixture was then stirred (at about 300 rpm) for about 0.5 hours to carry-out solution copolymerization of the monomers.

Then, at the end of copolymerization, 50 grams of methanol (as a radical transfer agent) was added into the autoclave to react with the fluorocopolymer. During the copolymerization of the fluorocopolymer, the end group should be a CH₂* radical group or a CFH* radical group. Thus, addition of a radical transfer agent (i.e., a reagent capable of reacting with a CH₂* radical group or a CFH* radical group, such as for example, an alcohol, an amine, or a hydrogen) should serve to endcap the end groups of the fluorocopolymer, and the resulting endgroups should preferably be ether groups (from an alcohol) and/or alkyl groups (from a hydrogen). Both ether groups and alkyl groups are much more thermally stable than the existing carboxylic acid end groups of the fluorocopolymer, and thus will result in a more thermally stable, endcapped fluorocopolymer. Although the endcapping process should greatly improve the thermal stability of the fluorocopolymer, it should not have an effect on the UV-light stability of the fluorocopolymer. In order to increase the yield of the endcapping reaction, the temperature of the mixture was increased from about 57° C. to about 130° C. after addition of the methanol. The mixture was then stirred (at about 300 rpm) for about 4 hours to carry out the endcapping reaction and produce a final, endcapped fluorocopolymer.

After the autoclave was cooled to room temperature, any unreacted monomers were purged and then the autoclave was opened and a vacuum was applied to the autoclave for a sufficient period of time to remove sufficient excess solvent to achieve a solid content (copolymer content) in the autoclave of about 67% by weight. The final fluorocopolymer had a weight of 821 grams, and a yield of 92%. The final fluorocopolymer (without solvent) was tested and found to have: a number average molecular weight in the range of about 12,000; a hydroxyl value of about 60 mg KOH/g; and a fluorine content of about 21 wt %. After post-treatment (filtering the zinc oxide and concentrating to a solid content of about 70%), the resulting final fluorocopolymer plus solvent combination was in the form of a clear solution having a solid, that is, copolymer, content of about 70%.

### Example 2—Coating Composition Preparation

A coating composition was then prepared using the final fluorocopolymer from Example 1 above. The coating composition was prepared from the following components:

| | | Weight | |
|---|---|---|---|
| Component | Name | (g) | Supplier |
| Fluoroco- | final fluorocopolymer | 58.6 | |
| polymer | from Example 1 | | |
| | above, 70% solid | | |
| | content | | |
| Pigment | carbon black FW200 | 2.5 | Orion Engineered |
| | | | Carbons |
| Pigment | R-960 titanium dioxide | 15.6 | DuPont ™ Ti-Pure ® |
| Dispersant | SOLSPERSE-32500 | 3 | Lubrizol Corp. |
| Solvent | butyl acetate | 20.3 | |
| Curing agent | Desmodur N 3900 | 12.4 | Covestro |
| | (NCO 19.6%) | | |

The coating composition was prepared as follows. A pigment paste mixture was made by mixing the fluorocopolymer, the pigments and the dispersant in a high-speed dispersion machine with glass beads to disperse the mixture and reduce the size of the pigment. The mixture was dispersed for about 3 hours at 3000 RPM, until the fineness of the composition was less than about 20 μm. The mixture was then filtered to remove the glass beads.

Next, the solvent was added to the pigment paste mixture, and the resulting mixture was well mixed by the high-speed dispersion machine for about 30 minutes at 1500 RPM. Then, the curing agent was added to the mixture, and the resulting mixture was again well mixed by the high-speed dispersion machine for about 30 minutes at 1500 RPM, thus forming the coating composition.

In order to form the coating film, conventional methods such as a brush, a roller, an air spray, an airless spray, a flow coater, a roll coater, a spin coater, and the like may be utilized, and the coating can be applied on various substrates. In addition, the coating film can be formed directly on a substrate or on a primer layer, or if necessary on an undercoating layer. In the present case, the coating film was applied to a substrate and the outermost cured coating film layer had a layer thickness of about 20-30 μm.

After coating was complete, the coated substrate was kept at room temperature (about 20-25° C.) for about one week to ensure that the outermost coating film layer was completely cured.

QUV-B durability testing was then performed on the coating composition having the final fluorocopolymer described above (denoted as FPVE-VBZ), and the results were compared to another coating composition having a fluorocopolymer that was prepared exactly the same way as FPVE-VBZ except that the vinyl benzoate monomer was not included in the fluorocopolymer (denoted as FPVE). The QUV-B is measured according to ASTM D 7251, which is QUV Accelerated Weathering Tester Operating Procedure by which accelerated testing is performed in an accelerated testing cabinet sold under the trade mark QUV® manufactured by Q-Lab Corporation of Cleveland, Ohio. Two lamps are used in this testing cabinet: “A” lamps (UVA-340) have a normal output of 0.69 W/m² @ 340 nm m and a maximum output of 1.38 W/m² @ 340 nm m; and “B” lamps (UVB-313) have a normal output of 0.67 W/m² @ 310 nm m and a maximum output of 1.23 W/m² @ 310 nm m. As used herein, the designation QUV-A refers to tests using the A lamps and QUV-B refers to tests using the B lamps. The procedure is accomplished using the following steps:
1. Measure the initial gloss of the coating film three times and obtain the average of the measurements, which is designated in the following calculations as “A.”
2. Place the test plate containing the coating in the panel holder in the cabinet and power the cabinet on.
3. Set the PROGRAM button in the control panel and select the desired program operation.
4. Engage the RUN button to start test.
5. Record down the exposure time indicated on the LED panel.
6. Stop the machine after the indicated hours, remove the test plate, and measure the gloss three times to get an average result for the indicated exposure time, and record this value as “B” for use in the calculation below.
7. Determine Gloss retention using the formula: Gloss Retention=B/A

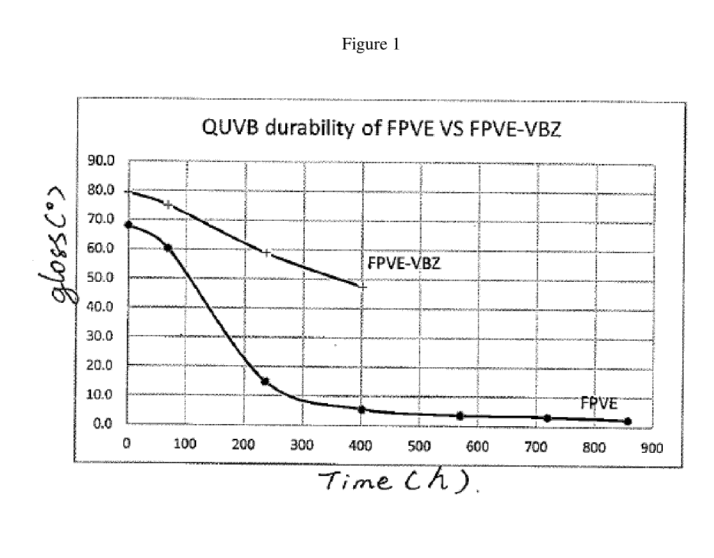

As can be seen in FIG. 1, the QUV-B durability of FPVE-VBZ is much better than that of FPVE. For example, after approximately 240 hours of exposure under UV-B light, the actual gloss of FPVE is around 15° while that of FPVE-VBZ is around 60° (wherein the actual gloss is the “B” value as described in the preceding paragraph). Similarly, after approximately 400 hours of exposure under UV-B light, the actual gloss of FPVE is around 5° while that of FPVE-VBZ is around 47°. Thus, these results show that inclusion of the aromatic vinyl ester monomer in the fluorocopolymer as described herein leads to an improvement in the QUV-B durability of the resulting fluorocopolymer.

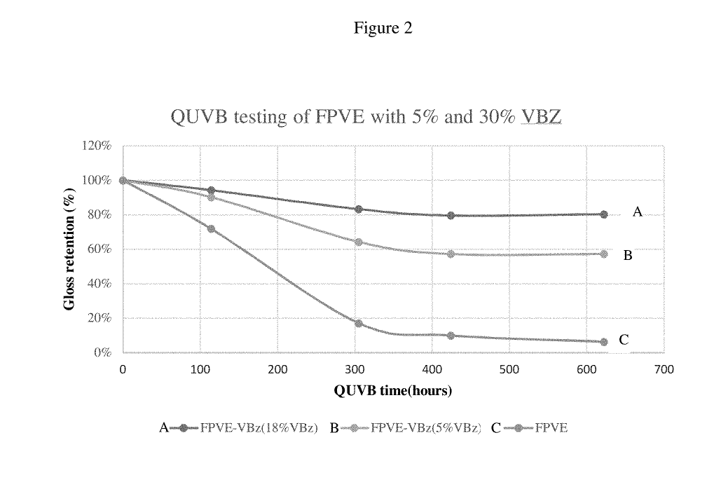

Additional coating compositions and fluorocopolymers were also produced and subjected to QUV-B durability testing, in accordance with the procedures described above in Examples 1 and 2. Specifically, two additional coating compositions having a fluorocopolymer were produced in accordance with the procedure described above in Examples 1 and 2, except that different amounts of the vinyl benzoate monomer were employed in the fluorocopolymer. One fluorocopolymer was produced with 30 mol % of the vinyl benzoate monomer (coating composition denoted as FPVE-VBZ (30% VBZ)), and another fluorocopolymer was produced with 5 mol % of the vinyl benzoate monomer (coating composition denoted as FPVE-VBZ (5% VBZ)). As can be seen in FIG. 2, the QUV-B durability of both FPVE-VBZ (30% VBZ) and FPVE-VBZ (5% VBZ) is much better than that of FPVE. For example, after approximately 600 hours of exposure under UV-B light, the gloss retention of FPVE-VBZ (30% VBZ) is around 80% and the gloss retention of FPVE-VBZ (5% VBZ) is around 58%, while that of FPVE is around 8%. Similarly, after approximately 300 hours of exposure under UV-B light, the gloss retention of FPVE-VBZ (30% VBZ) is around 83% and the gloss retention of FPVE-VBZ (5% VBZ) is around 65%, while that of FPVE is around 18%. Thus, these results also show that inclusion of the aromatic vinyl ester monomer in the fluorocopolymer as described herein leads to an improvement in the QUV-B durability of the resulting fluorocopolymer.

In addition, although no QUV-A testing was done, because QUV-A testing generally has a much lower dosage of UV-light than does QUV-B testing, we would expect the color change and gloss retention in QUV-A testing to be better than those in QUV-B testing.

What is claimed is:

1. A fluorocopolymer formed by copolymerization of:
(1) one or more hydrofluoroolefin monomer(s) selected from the group consisting of hydrofluoroethylenes, hydrofluoropropenes, hydrofluorobutenes, hydrofluoropentenes and combinations of these;
(2) one or more aromatic vinyl ester monomer(s);
(3) one or more vinyl ester monomer(s); and
(4) one or more vinyl ether monomer(s), wherein at least a portion of said vinyl ether monomer is a hydroxyl group-containing vinyl ether monomer.

2. The fluorocopolymer of claim 1, wherein the one or more aromatic vinyl ester monomers comprises a monomer represented by the formula CH₂═CH—O(C═O)-(A), wherein (A) represents a phenyl group with or without a side group.

3. The fluorocopolymer of claim 1, wherein the one or more aromatic vinyl ester monomers comprises vinyl benzoate.

4. The fluorocopolymer of claim 1, wherein the one or more hydrofluoroolefin monomer(s) is selected from hydrofluoropropenes.

5. The fluorocopolymer of claim 4, wherein the one or more hydrofluoroolefin monomer(s) is selected from 2,3,3,3-tetrafluoropropene, 1,3,3,3-tetrafluoropropene, and combinations thereof.

6. The fluorocopolymer of claim 5, wherein the one or more hydrofluoroolefin monomer(s) is 1,3,3,3-tetrafluoropropene.

7. The fluorocopolymer of claim 6, wherein the 1,3,3,3-tetrafluoropropene comprises trans-1,3,3,3-tetrafluoropropene.

8. A fluorocopolymer formed by copolymerization of:
(1) from about 40 mol % to about 60 mol % hydrofluoropropene monomers;
(2) from about 2 mol % to about 40 mol % aromatic vinyl ester monomers;
(3) from about 5 mol % to 45 mol % of vinyl ester, vinyl ether or a mixture thereof;
wherein the vinyl ester has the formula CH₂═CR¹—O(C═O)ₓR² wherein x is 1, R¹ is a hydrogen or a methyl group, and R² is selected from the group consisting of an unsubstituted straight-chain, branched-chain or alicyclic alkyl group having 1 to 12 carbon atoms; and wherein the vinyl ether has the formula CH₂═CR³—OR⁴, wherein R³ is a hydrogen or a methyl group, and R⁴ is selected from the group consisting of an unsubstituted straight-chain, branched-chain or alicyclic alkyl group having 1 to 12 carbon atoms; and
(4) from about 3 mol % to about 30 mol % of hydroxyalkyl vinyl ether having the formula CH₂═CR³—O—R⁵—OH, where R³ is a hydrogen or a methyl group, and R⁵ is selected from the group consisting of a C2 to C12 unsubstituted straight-chain, branched-chain or alicyclic alkyl group having from 3 to 5 carbons;
wherein the mol % are based on the total of the monomers.

9. The fluorocopolymer of claim 8, comprising from about 45 mol % to about 55 mol % of hydrofluoropropene monomers.

10. The fluorocopolymer of claim 8, comprising about 50 mol % of hydrofluoropropene monomers.

11. The fluorocopolymer of claim 8, wherein the hydrofluoropropene monomers are selected from the group consisting of HFO-1234ze, HFO-1234yf and combinations of these.

12. The fluorocopolymer of claim 8, wherein the hydrofluoropropene monomers are trans-HFO-1234ze.

13. The fluorocopolymer of claim 8, comprising from about 5 mol % to about 20 mol % of aromatic vinyl ester monomers.

14. The fluorocopolymer of claim 8, wherein the aromatic vinyl ester monomers comprise a monomer represented by the formula CH₂═CH—O(C═O)-(A), wherein (A) represents a phenyl group with or without a side group.

15. The fluorocopolymer of claim 8, wherein the aromatic vinyl ester monomers comprise vinyl benzoate.

16. The fluorocopolymer of claim 8, comprising from about 10 mol % to about 40 mol % of vinyl ester, vinyl either or a mixture thereof.

17. The fluorocopolymer of claim 8, comprising from about 20 mol % to about 40 mol % of vinyl ester, vinyl either or a mixture thereof.

18. The fluorocopolymer of claim 8, comprising from about 3 mol % to about 20 mol % of the hydroxyalkyl vinyl ether.

19. The fluorocopolymer of claim 8, comprising from about 3 mol % to about 10 mol % of the hydroxyalkyl vinyl ether.

20. A fluorocopolymer coating composition comprising:
(i) one or more fluorocopolymers formed by the copolymerization of
(1) first monomer(s) consisting essentially of trans-HFO-1234ze in an amount of from about 40 mol % to about 60 mol %,
(2) second monomer(s) consisting essentially of vinyl benzoate in an amount of from about 2 mol % to about 40 mol %,
(3) third monomer(s) comprising:
A) vinyl ester monomer represented by formula CH₂═CR¹—O(C═O)ₓR² wherein x is 1 and wherein R¹ is either hydrogen or a methyl group and wherein R² is an unsubstituted branched-chain alkyl group having 6 to 8 carbon atoms including at least one tertiary or at least one quaternary carbon atom, wherein said vinyl ester monomer is present in an amount of from about 5 mol % to about 45 mol; and
B) vinyl ether monomer(s), represented by formula CH₂═CR³—O—R⁴, wherein R³ is either hydrogen or a methyl group and wherein R⁴ is selected from the group consisting of a substituted or unsubstituted straight-chain or branched-chain alkyl group having 1 to 3 carbon atoms, said vinyl ether monomer(s) preferably being present in amounts of from about 10 mol % to about 40 mol %; and
(4) fourth monomer(s) consisting of hydroxyalkyl vinyl ether represented by the formula CH₂═CR³—O—R⁵—OH, where R³ is either hydrogen or a methyl group and R⁵ is selected from the group consisting of a substituted or unsubstituted straight-chain or branched-chain C3 to C5 alkyl, wherein the amount of said fourth monomer is preferably from about 3 mol % to about 30 mol %; and
(ii) a carrier comprising one or more VOC compounds;
wherein the coating composition comprises not greater than about 30% by weight of said carrier.
